(19) United States
(12) Patent Application Publication
(10) Pub. No.: US 2023/0214646 A1
(43) Pub. Date: Jul. 6, 2023

(54) METHOD AND SYSTEM FOR SEARCHING DEEP NEURAL NETWORK ARCHITECTURE

(71) Applicant: SAMSUNG ELECTRONICS CO., LTD., SUWON-SI (KR)

(72) Inventors: CHAN-HYUN YOUN, DAEJEON (KR); KYUNGCHAE LEE, DAEJEON (KR); LINH LE VU, DAEJEON (KR); HEEJAE KIM, JEJU-DO (KR)

(73) Assignee: Korea Advanced Institute of Science and Technology, Daejeon (KR)

(21) Appl. No.: 17/856,569

(22) Filed: Jul. 1, 2022

(30) Foreign Application Priority Data
Jan. 3, 2022 (KR) 10-2022-0000466

(51) Int. Cl. G06N 3/08; G06N 3/04; G06N 3/063

(52) U.S. Cl. CPC G06N 3/08; G06N 3/04; G06N 3/063

(57) ABSTRACT

A method for searching deep neural network architecture for computation offloading in a computing environment is provided. The method comprises configuring a target deep network including a plurality of computation cells, each computation cell including a plurality of nodes, a weight between each node of the plurality of nodes, and an operation selector that selects a candidate operation between each node of the plurality of nodes, partitioning the plurality of computation cells into a first portion in which the computation is performed on the first device and a second portion in which the computation is performed on the second device, the first portion including a transmission cell, and the transmission cell including a resource selector that determines whether each computation inside the transmission cell is processed by the first device or the second device, and a channel selector which determines a channel through which a computation result processed by the first device is transmitted to the second device, and updating the weight, the operation selector, the resource selector, and the channel selector.

This U.S. non-provisional patent application claims priority under 35 U.S.C. § 119 to Korean Patent Application No. 10-2022-0000466, filed on Jan. 3, 2022, in the Korean Intellectual Property Office, the disclosure of which is incorporated herein by reference in its entirety.

### BACKGROUND

### 1. Field

The present disclosure relates to an inference computation pipeline technique of a deep network based on a deep neural network architecture search in an edge computing environment. Specifically, the present disclosure relates to a method for performing a deep neural network architecture search in consideration of computing characteristics between a mobile device and an edge server and communication characteristics at the time of computation offloading, and building an efficient deep network inference computation collaboration pipeline between the mobile device and the edge server on the basis of the method for performing a deep neural network architecture search.

### 2. Description of the Related Art

Computation offloading is a technique that does not process a computation in a single computation unit such as a mobile device when executing a computing task. Instead, computation offloading involves performing a computation through collaboration with a computation unit such as a server that has a large capacity computation resource.

There are several types of collaboration between computation units. For example, there is one type of collaboration that includes allocating the same task on multiple inputs to each of multiple computation units as an input unit, such as a horizontal parallelization. There is also another type of collaboration that includes allocating one task consisting of multiple steps on a single input to each of multiple computation units for each step, such as a vertical parallelization or a model parallelization.

In the case of real-life AI (artificial intelligence) applications, the number of which has increased significantly in recent years, there is a feature in which computation is performed on the basis of multiple mobile devices including mobile phone terminals Mobile devices are the most popular computation devices due to their characteristics. In general, because individual mobile devices do not have sufficient computing resources for supporting AI applications, a situation in which the computing resources are insufficient may be overcome through computation offloading.

From a viewpoint of a computational capability, computation offloading generally has an advantage of allowing a mobile device having poor task capability to support a wide range of applications, by allocating tasks to nearby edge servers based on hardware accelerators with powerful computing performance. An example of a hardware accelerator with powerful computing performance is a GPU (Graphic Processing Unit. GPUs have multiple cores configured to work in parallel. The original purpose of GPUs was simply to process graphic data for pixels in parallel, but GPUs are increasingly employed to work in fields outside of graphics. In addition, when the edge server is made to effectively perform the computation of the mobile device, improvements in the usage efficiency of computing resources may be obtained along with enhancements of the quality of the overall application execution.

In such offloading situations, in order to overcome multiple obstacles such as communication delay from the mobile device to the edge server with powerful computing performance, various technologies related to deep network model compression such as pruning and quantization have been proposed.

As a technique, deep neural network architecture search refers to a technique in which the structure is automatically determined in the learning process of the deep network.

In the existing general deep learning, a type of collaboration includes using the deep network design defined by humans without change. However, the deep network subjected to the neural network architecture search technique such as automated machine learning (AutoML) simultaneously learns neural network architecture and weights optimized to satisfy the goal according to a given learning goal, and has the advantage of effectively constructing deep networks with special purposes.

To this end, many deep neural network architecture search algorithms use a method for defining candidate operations between deep network internal nodes and learning the selection probabilities of the operations on the basis of Stochastic Gradient Descent (SGD) to select the optimum operation among the candidate operations.

In the computation offloading situations, because the mobile device and the edge server are physically separated, a transmission overhead through wired communication or wireless communication occurs. Due to this transmission overhead, there are factors to consider when performing offloading in the edge computing environment.

First, in the case of the type of collaboration that includes transferring some, most or all the inference computations in the mobile device to the edge server, there is an effect that the computation execution time is shortened due to the high computation capability of the edge server. Further, when the method for searching deep neural network architecture is applied to the edge server, an effect of improving the inference accuracy by the optimum computation selection may be obtained.

However, in this case, there is a problem that a communication load occurs in the process of transferring the input data from the mobile device to the edge server, and the computation capability of the mobile device is wasted. Furthermore, since most of the conventional methodologies for searching deep neural network architecture are generally developed with a focus on improving prediction accuracy, it is difficult to obtain advantages such as a decrease in inference execution time.

Second, it is possible to consider a type of collaboration (for example, Neurosurgeon 3) in which an intermediate stage computation of the deep network is performed in the mobile device and the rest is allocated to the edge server. When considering this type of collaboration, if a partitioning point of the deep network is correctly selected, it is possible to achieve efficiency of high resource utilization and reduced inference execution time, in consideration of differences in computing performance between the mobile device and the edge server. Further, in some cases, the communication efficiency may be improved by reducing the amount of data transmission from the mobile device to the edge server as compared with the first type.

However, in this type of collaboration, it is very difficult to find the correct partitioning point in situations in which dynamic changes of the computing resource situation and communication situation of the mobile device and the edge server are severe. For example selection of the partitioning point depending on the situation may increase inference delay times.

As a method for alleviating this, deep network computation offloading techniques using deep network pruning or the like (for example, two-step pruning) may be considered.

However, since the initial design of the neural network architecture used by the technique is performed without considering offloading, there is a limitation that only a limited level of optimization may be achieved, or a trade-off between inference execution time and prediction accuracy occurs.

For example, in the case of the two-step pruning technique, the data communication amount is reduced by about 26 times and the computation acceleration of about 6 times is achieved. However, there is a problem that the prediction accuracy decreases by about 4%.

### SUMMARY

Aspects of the inventive concept(s) described herein provide a method for searching deep neural network architecture of a target deep network for accelerating deep network inference in a computation offloading environment from a mobile device to an edge server.

In the computation offloading environment, the mobile device and the edge server are connected through wired communication or wireless communication, and the mobile device and the edge server perform computation-intensive deep network inference computations in cooperation with each other.

Aspects of the inventive concept(s) described herein also provide a system capable of managing and performing computation offloading/pipelining for deep network inference between a mobile device and a server in a mobile edge computing environment, and provide a method for designing a deep network structure through a deep neural network architecture search, which may be optimized for the environment at the time of computation offloading to allow achieve high inference accuracy, low delay time and high communication efficiency at the same time.

According to some aspects of the inventive concept(s) described herein, a method searches deep neural network architecture for computation offloading in a computing environment in which a computation is performed using a first device and a second device. The method comprises configuring a target deep network including a plurality of computation cells, each computation cell including a plurality of nodes, a weight between each node of the plurality of nodes, and an operation selector that selects a candidate operation between each node of the plurality of nodes. The method also comprises partitioning the plurality of computation cells into a first portion in which the computation is performed on the first device and a second portion in which the computation is performed on the second device, the first portion including a transmission cell, and the transmission cell including a resource selector that determines whether each computation inside the transmission cell is processed by the first device or the second device, and a channel selector which determines a channel through which a computation result processed by the first device is transmitted to the second device. The method further comprises updating the weight, the operation selector, the resource selector, and the channel selector.

According to some aspects of the inventive concept(s) described herein, a system searches deep neural network architecture for computation offloading in a computing environment in which a computation is performed using a first device and a second device. The system comprises a processor, and a memory configured to store a command. When the command in the memory is executed by the processor, the processor is configured to configure a target deep network including a plurality of computation cells, each computation cell including a plurality of nodes, a weight between each node of the plurality of nodes, and an operation selector that selects a candidate operation between each node of the plurality of nodes; partition the plurality of computation cells into a first portion in which the computation is performed on the first device and a second portion in which the computation is performed on the second device, the first portion including a transmission cell, and the transmission cell including a resource selector that determines whether each computation inside the transmission cell is processed by the first device or the second device, and a channel selector which determines a channel through which a computation result processed by the first device is transmitted to the second device; and update the weight, the operation selector, the resource selector, and the channel selector.

According to some aspects of the inventive concept(s) described herein, a non-transitory computer-readable recording medium stores a program that, when executed by a processor, performs a method for searching deep neural network architecture for computation offloading in a computing environment in which a computation is performed using a first device and a second device. The method for searching deep neural network architecture comprises configuring a target deep network including a plurality of computation cells, each computation cell including a plurality of nodes, a weight between each node of the plurality of nodes, and an operation selector that selects a candidate operation between each node of the plurality of nodes; partitioning the plurality of computation cells into a first portion in which the computation is performed on the first device and a second portion in which the computation is performed on the second device, the first portion including a transmission cell, and the transmission cell including a resource selector that determines whether each computation inside the transmission cell is processed by the first device or the second device, and a channel selector which determines a channel through which a computation result processed by the first device is transmitted to the second device; and updating the weight, the operation selector, the resource selector, and the channel selector.

### BRIEF DESCRIPTION OF THE DRAWINGS

The above and other aspects and features inventive concept(s) described herein will become more apparent by describing in detail exemplary embodiments thereof referring to the attached drawings, in which:

FIG. 1 is a flowchart illustrating a method for searching deep neural network architecture according to some embodiments;

FIG. 2 and FIG. 3 are diagrams for explaining the method for searching deep neural network architecture according to some embodiments;

FIG. 4 is a diagram illustrating candidate operations between respective computation cell internal nodes;

FIG. 5 is a diagram illustrating a resource selector in a transmission cell;

FIG. 6 is a diagram illustrating a channel selector in the transmission cell;

FIG. 7 is a diagram for explaining a method for searching the deep neural network architecture according to some embodiments; and

FIG. 8 is a block diagram of an electronic device in the network environment according to some embodiments.

### DETAILED DESCRIPTION OF THE EMBODIMENTS

Hereinafter, embodiments of the inventive concept(s) described herein will be described referring to the accompanying drawings.

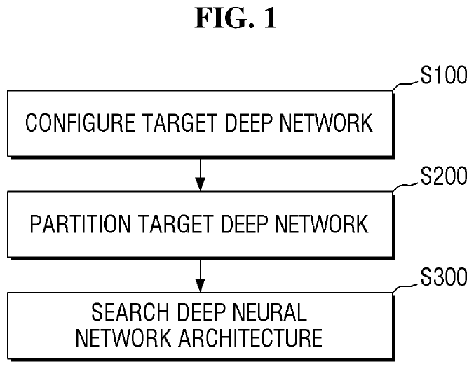

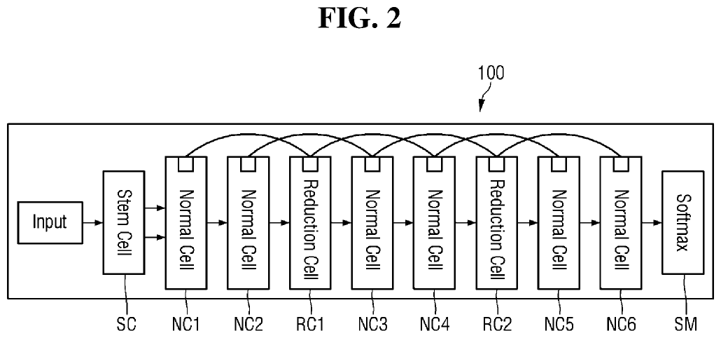

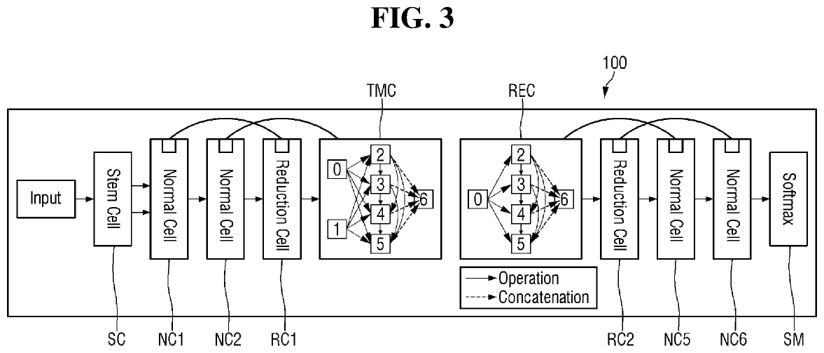

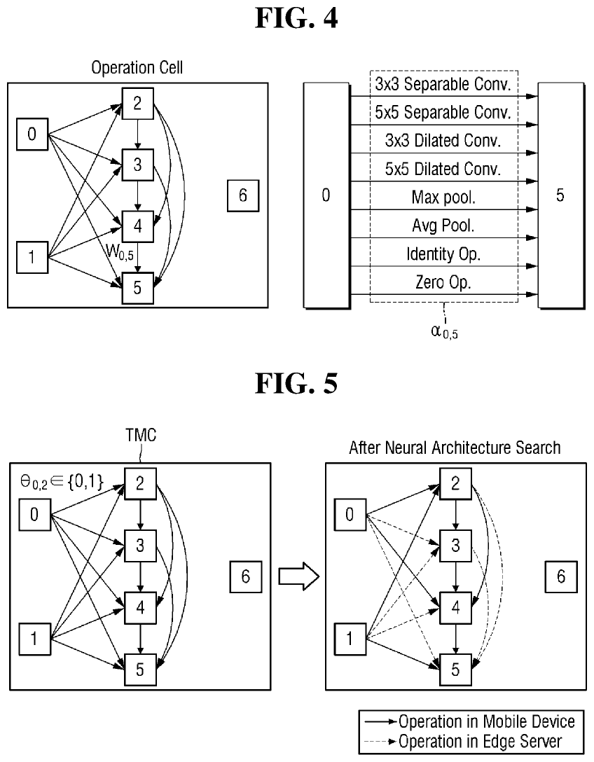

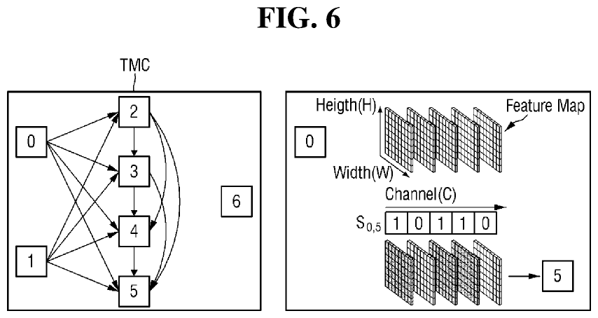

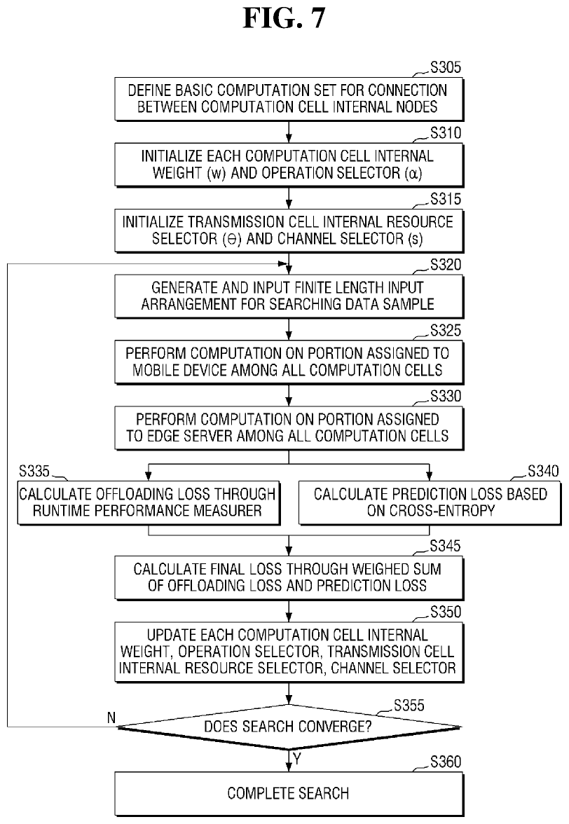

FIG. 1 is a flowchart illustrating a method for searching deep neural network architecture according to some embodiments. FIG. 2 and FIG. 3 are diagrams for explaining the method for searching deep neural network architecture according to some embodiments. FIG. 4 is a diagram illustrating candidate operations between respective computation cell internal nodes. FIG. 5 is a diagram illustrating a resource selector in a transmission cell. FIG. 6 is a diagram illustrating a channel selector in the transmission cell. FIG. 7 is a diagram for explaining a method for searching the deep neural network architecture according to some embodiments.

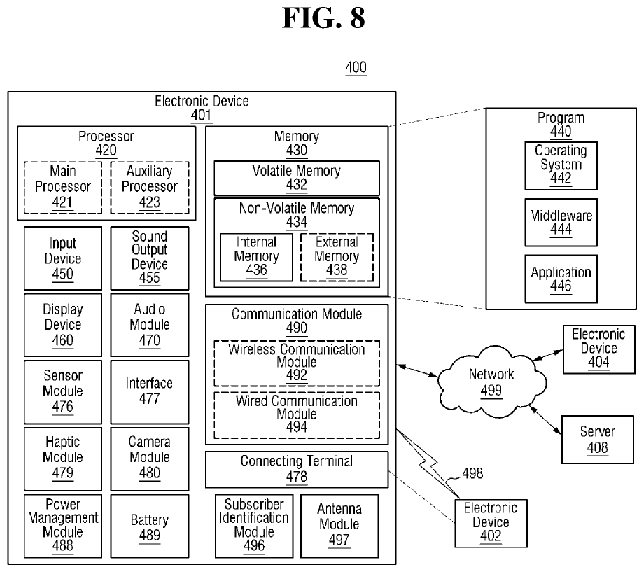

Referring to FIG. 1, a target deep network is configured (S100). The target deep network may be configured as a logical arrangement of resources provided by a network architecture for implementing a deep neural network. The target deep network may be configured based on a template or library of potential computation cells which may be used to dynamically configure target deep networks. An example network architecture is shown in and described with respect to FIG. 8, wherein a first device may comprise an electronic device 401, and a second device may comprise any of the external electronic device 402, the external electronic device 404, or the server 408. The server 408 may comprise an edge server, for example. The first device and the second device may be connected by wired communication or wireless communication. A target deep network is shown in and described with respect to FIG. 2.

FIG. 2 and FIG. 3 are diagrams for explaining the method for searching deep neural network architecture according to some embodiments. Referring to FIG. 2, a target deep network 100 may include a plurality of computation cells. The plurality of computation cells of the target deep network 100 may include, for example, one basic cell SC (labelled “Stem Cell” in FIG. 2), six normal cells NC1 to NC6, two reduced cells RC1 and RC2 (each labelled “Reduction Cell” in FIG. 2), and one Softmax layer SM. As explained below with respect to FIG. 3, the target deep network 100 and any other target deep networks described herein may be partitionable so that different operations may be performed on and by different devices when determined to be efficient.

Here, the normal cells NC1 to NC6 and the reduced cells RC1 and RC2 may have the same structure. However, in the reduced cells RC1 and RC2, a spatial resolution of a feature map may be additionally reduced by, for example, half. The Softmax layer SM may consider, for example, an image classification task based on a convolutional neural network.

Referring to FIG. 1 again, the target deep network is partitioned (S200).

Referring to FIG. 3, the target deep network 100 may be partitioned for offloading to an edge server. The offloading may comprise dynamically assigning some operations to be performed by some computation cells of the partitionable target network from a first device to a second device, so that some operations are performed by the first device and some operations are performed by the second device. In some embodiments, the partitionable target network may be divided between more than the first device and the second device. Here, a case where the partitioning point exists between the normal cell NC3 and the normal cell NC4 of FIG. 2 will be described as an example. A partition point may be considered a form of dividing line between computation cells of the partitionable target network, wherein the computation cells of the partitionable target network are divided between a first group implemented on and by the first device and a second group implemented on and by the second device.

For the determined partitioning point, the computation cell (e.g., NC3 of FIG. 1) immediately before the partitioning point serves as a transmission cell TMC. The transmission cell TMC may be defined by a number of nodes, such as six nodes (0 to 5), and computations between the number of nodes as shown. There are several candidate operations between each node, and one of the candidate operations may then be selected as a final computation in the deep neural network architecture searching step.

In such a target deep network 100, the basic cell SC, the normal cells NC1, NC2, NC5 and NC6, and the reduced cells RC1 and RC2, may have the same structure as the internal structure of the transmission cell TMC shown. However, a receiving cell REC may have one input node, for example, as in 0^{th} node of receiving cell REC, unlike other cells such as the transmission cell TMC.

In such a target deep network 100, when the execution of the deep neural network architecture search is completed, one of the internode candidate operations defined in each computation cell is selected. Additionally, in the case of the transmission cell TMC, resources for processing the computations are selected for each internal computation of the transmission cell TMC. For example, a determination may be made as to whether each computation is to be processed by a mobile device or an edge server.

On the basis of this, in the subsequent inference process, the computations assigned to the mobile device among the computation cells before the transmission cell TMC and the internal computation of the transmission cell TMC are processed by the mobile device. The remaining computations are processed in the edge server, by transferring the computation result of the mobile device to the edge server through a communication module.

FIG. 4 is a diagram illustrating candidate operations between respective computation cell internal nodes. Referring to FIG. 4, for example, eight candidate operations (3×3 Separable Convolution, 5×5 Separable Convolution, 3×3 Dilated Convolution, 5×5 Dilated Convolution, Max Pooling, Average Pooling, Identity Operation, and Zero Operation) may be considered in relation to the computation from node 0 to node 5. This candidate operation may be applied equally between other nodes, and may be applied equally between the nodes of other cells.

Here, w_{0,5} represents the weight between node 0 and node 5, and α_{0,5} represents the operation selector between node 0 and node 5.

After that, when the deep neural network architecture search (S30 of FIG. 1) is performed, α_{0,5} is updated. During the search process, the computation selection may be performed as in Formula 1 to make the search space continuous.

$${\tilde{o}}_{\text{?}} ( x ) = {\sum }_{o ∈ 𝒪} \frac{exp ( {α}_{\text{?}}^{o} )}{{\sum }_{{o}^{′} ∈ 𝒪} exp ( {α}_{\text{?}}^{{o}^{′}} )} {o}_{( \text{?} )} ( x ) \qquad [ Formula 1 ]$$

$$\text{?} \text{indicates text missing or illegible when filed}$$

Here, o_{(0,5)}(x) represents each candidate operation for the input x from node 0 to node 5, and thus α_{0,5}^{o} represents each operation selector parameter from node 0 to node 5. O includes the eight candidate operations described above as the entire set of operations. After the search is finished, the final operation is determined as o_{0,5}(x)=argmax_{o∈O}α_{0,5}^{o} instead of FIG. 5 is a diagram illustrating a resource selector in a transmission cell. Referring to FIG. 5, in an embodiment, the resource selector may be represented by θ, and the elements thereof may have a Boolean binary value of 0 or 1, as shown. However, when the value form is limited to a Boolean binary vector from the beginning, because backward propagation-based deep network learning techniques cannot be used, there is a need for a task that adjusts and defines the elements of θ in a learnable form. Therefore, θ may be defined as a vector having a differentiable form as shown in Formula 2 below.

$${θ}^{′} = \frac{\{ {θ}_{0.2} , … , {θ}_{4 , S} \} ⊙ \{ \vert 1 / {θ}_{0.2} \vert , … , \vert 1 / {θ}_{4 , S} \vert \} + \text{?}}{2} \qquad [ Formula 2 ]$$

$$\text{?} \text{indicates text missing or illegible when filed}$$

Here, ⊙ refers to a Hadamard Product, and the differentiability of Formula 2 is the same as the learnability on a general deep learning framework. Even when using other formula models that substitute the binary vector for the real number vector in the form in which a computation graph may be defined, the same or a similar effect that is implemented according to the teachings herein may be achieved.

After that, when the deep neural network architecture search (S300 of FIG. 1) is executed, θ is updated, and finally a determination may be made as to whether each computation inside the transmission cell TMC is processed by the mobile device or the edge server.

FIG. 6 is a diagram illustrating a channel selector in the transmission cell. Referring to FIG. 6, regarding the computation from node 0 to node 5, when the result value of the computation is given as a height H, a width W, and a number of channels C, the channel selector s_{0,5} may be defined as a one-dimensional Boolean vector by the number of channels C. The channel selector s_{0,5} may determine a channel through which a computation result processed by a first device is transmitted to a second device. Similar to the resource selector described above, the channel selector may be configured in a backward propagation format as in Formula 3.

$${s}_{\text{?}}^{′} = \frac{\{ {s}_{0.5}^{1} , … , {s}_{0.5}^{C} \} ⊙ \{ \vert 1 / {s}_{0 , S}^{1} \vert , … , \vert 1 / {s}_{0.5}^{C} \vert \} + \text{?}}{2} \qquad [ Formula 3 ]$$

$$\text{?} \text{indicates text missing or illegible when filed}$$

After that, when the deep neural network architecture search (S300 of FIG. 1) is performed, s_{0,5} is updated, and when there are five channels as shown, only the channel whose channel selector value is 1 may be transferred to the node 5 as the result value.

Referring to FIG. 1 again, the deep neural network architecture search is performed (S300).

FIG. 7 is a diagram for explaining a method for searching the deep neural network architecture according to some embodiments. Referring to FIG. 7, a basic computation set for connection between computation cell internal nodes is defined (S305). For example, the above-mentioned eight candidate operations may be defined.

Next, the internal weight and operation selector inside each computation cell, and the internal resource selector and the channel selector inside the transmission cell are initialized (S310, S315).

A full-scale search algorithm proceeds after the initialization task. First, a finite length input arrangement for searching data sample is generated (S320). In some embodiments, when taking the image classification task as an example, the searching data samples have the form of an RGB image and may be partitioned into a training dataset and a validation dataset.

In some embodiments, a preprocessing process may be defined when generating an input batch for the searching data sample. In such a preprocessing process, a normalization, a random extraction (crop), and a horizontal flip may be considered as data augmentation.

After generating the finite length input batch, the generated batch is input to a target deep network to perform feedforward propagation process, the computation is performed on a portion of the computation cell(s) assigned to the mobile device (S325), and the computation is performed on a portion of the computation cell(s) assigned to the edge server (S330). The computation cell(s) assigned to the mobile device may be a first portion, and the computation cell(s) assigned to the edge server may be a second portion.

When such a feedforward propagation process is completed, a loss L for the result is calculated (S335, S340, and S345). The computation performed on the first portion of the computation cell(s) assigned to the mobile device and the computation on the second portion of the computation cell(s) assigned to the edge server may be performed to calculate the loss L based on the computation on the first portion and the computation on the second portion. A weight, an operation selector, a resource selector, and a channel selector may be updated through a backward propagation based on the calculated loss L.

Here, the loss L may be largely classified into an offloading loss L_{off} and a prediction loss L_{pred} as in Formula (4). The loss L may be calculated, and calculating of the loss L may thus include calculating the offloading loss L_{off} at S335, calculating the prediction loss L_{pred} at S340, and calculating the loss L as a final loss through a weighted sum of the offloading loss L_{off} and the prediction loss L_{pred} at S345.

L=λ_{off}*L_{off}(w,α,θ,s)+λ_{pred}*L_{pred}(w,α,θ,s) [Formula 4]

Here, λ_{off}, λ_{pred} are linear combination coefficients of each of the offloading loss and the prediction loss, respectively, and hyperparameters that may be adjusted by a subject (e.g., a user) who performs the deep neural network architecture search.

The offloading loss L_{off} consists of a linear combination of execution loss L_{exec} and transmission loss Lₜᵣₐₙₛ as in Formula 5. The execution loss and the transmission loss may be obtained by calculating a ratio of a predetermined maximum value to the feedforward propagation execution time and an amount of data transmission from the mobile device to the edge server, respectively.

L_{off}=λ_{exec}*L_{exec}(w,α,θ,s)+λₜᵣₐₙₛ*Lₜᵣₐₙₛ(w,α,θ,s) [Formula 5]

Here, λ_{exec}, λₜᵣₐₙₛ are hyperparameters, and each refer to the linear combination coefficients of the execution loss and the transmission loss, respectively.

The prediction loss consists of a linear combination of a training loss and a validation loss Lᵥₐₗ as in Formula 6. The training loss and the validation loss may be obtained by calculating cross-entropy of the training data placement and validation data, respectively.

L_{pred}=λₜᵣ*Lₜᵣ(w,α,θ,s)+λᵥₐₗ*Lᵥₐₗ(w,α,θ,s) [Formula 6]

Here, λₜᵣ, λᵥₐₗ are hyperparameters, and each refer to the linear combination coefficients of the execution loss and the transmission loss, respectively.

For example, in the existing methodologies for searching the deep neural network architecture, the update is performed only on α along with the weight w as in Formula 7.

w←w−η_{w}∇_{w}Lᵤ(w,α).

α←α−η_{α}(λₜᵣ∇_{α}Lᵤ(w,α)+λᵥₐₗ∇_{α}Lᵥₐₗ(w,α)) [Formula 7]

Here, η_{w}, η_{α} refer to the learning rate of w, α, respectively

However, in order to consider the offloading between the mobile device and the edge server, as in Formula 8 below, a deep neural network architecture search through the backward propagation based on a stochastic gradient descent method is performed. As a result, the internal weight and the operation selector inside each computation cell, and the internal resource selector and the channel selector inside the transmission cell are updated (S350).

w←w−η_{w}∇_{w}Lₜᵣ(w,α,θ,s),

α←α−η_{α}(λₜᵣ∇ᵤLₜᵣ(w,α,θ,s)+λᵥₐₗ∇_{α}Lᵥₒₗ(w,α,θ,s)+λ_{off}∇_{α}L_{off}(w,α,θ,s),

θ←θ−η_{θ}(λₜᵣ∇_{θ}Lᵤ(w,α,θ,s)+λᵥₐₗ∇_{θ}Lᵥₐₗ(w,α,θ,s)+λ_{off}∇_{θ}L_{off}(w,α,θ,s)),

s←s−ηₛ(λₜᵣ∇ₛLᵤ(w,α,θ,s)+λᵥₐₗ∇ₛLᵥₐₗ(w,α,θ,s)+λ_{off}∇ₛL_{off}(w,α,θ,s)) [Formula 8]

Here, η_{w}, η_{α}, η_{θ}, ηₛ refer to each learning rate.

After that, whether the search converges is determined (S355). When the search converges (S355-Y), the search is completed and inference is performed (S360). When the search does not converge (S355-N), the training processes (S320 to S350) are repeated.

In this way, an improved deep neural network architecture search algorithm is provided based on offloading the computation from the mobile device to the edge server for accelerating the deep network inference.

Both the prediction loss and the inference execution time and the data transmission time are considered together as the loss function. The difference in computation capability between the mobile device and the edge server in the deep neural network architecture search is effectively reflected. Therefore, high prediction performance may be ensured in the inference process, and the inference execution time may also be shortened.

Furthermore, the channel selector described herein makes it possible to effectively reduce the amount of data transmission from the mobile device to the edge server and accelerate the inference process without significantly reducing prediction performance.

The above-noted teachings enable design of a the deep neural network architecture optimized for offloading situations between the mobile device and the edge server. The teachings also effectively solve problems such as an accuracy degradation of the existing deep network model compression-based offloading methodologies.

FIG. 8 is a block diagram of the electronic device inside the network environment according to some embodiments.

As shown, the electronic system 400 includes an electronic device 401, an external electronic device 402 (e.g., a first external electronic device), an external electronic device 404 (e.g., a second external electronic device), a server 408 and a first network 498 and a second network 499. In some embodiments, the electronic device 401 and electronic system 400 shown in FIG. 8 may be used to implement the method for searching the deep neural network architecture described above.

An electronic device 401 inside the network environment 400 may communicate with the external electronic device 402 through a first network 498, or may communicate with the external electronic device 404 or the server 408 through a second network 499. The first network 498 may be, for example, a short-range wireless communication network. The second network 499 may be, for example, a long-range wireless communication network. A target deep network described herein may be configured as a logical arrangement of resources of a network architecture shown in FIG. 8 for implementing a deep neural network. A first device described herein may comprise an electronic device 401, and a second device described herein may comprise any one (or more) of the external electronic device 402, the external electronic device 404, or the server 408. The server 408 may comprise an edge server, for example.

The electronic device 401 may include a processor 420, a memory 430, an input device 450, an sound output device 455, an image display device 460, an audio module 470, a sensor module 476, an interface 477, a haptic module 479, a camera module 480, a power management module 488, a battery 489, a communication module 490, a subscriber identification module 496 (SIM), an antenna module 497, and the like.

In some embodiments, at least one of the components, such as, for example, the image display device 460 or the camera module 480 may be omitted from the electronic device 401, or one or more other components may be added to the electronic device.

In some embodiments, some of the components may be implemented as a single integrated circuit (IC). For example, the sensor module 476 such as a fingerprint sensor, an iris sensor, and an illuminance sensor may be embedded inside an image display device such as a display.

The processor 420 may execute software (e.g., program 440) that controls other components of at least one instance of the electronic device 401, such as hardware or software components connected to the processor 420, to perform various data processing and computations.

As at least a part of data processes or computations, the processor 420 may load command or data received from other components, such as the sensor module 476 or the communication module 490, into a volatile memory 432, process the command or data loaded in the volatile memory 432, and store the result data in the non-volatile memory 434.

The processor 420 may include, for example, a main processor 421 (such as a central processing unit (CPU) or a smartphone central processor (e.g., an application processor AP)), and an auxiliary processor 423 that operates independently of the main processor 421 or operates in connection with the main processor 421.

Such an auxiliary processor 423 may include, for example, a graphic processing unit (GPU), an image signal processor (ISP), a sensor hub processor, a communication processor (CP) or the like.

In some embodiments, the auxiliary processor 423 may be configured to consume less power than the main processor 421 or to perform a particular function. The auxiliary processor 423 may be separated from the main processor 421 or implemented as a part thereof.

The auxiliary processor 423 may control at least some of the functions or states associated with at least one component among the components of the electronic device 401, on behalf of the main processor 421 while the main processor 421 is inactive, and together with the main processor 421 while the main processor 421 is active.

The memory 430 may store various data used in at least one component of the electronic device 401. The various data may include, for example, software such as program 440, and input data and output data for commands associated therewith. The memory 430 may include a volatile memory 432 and a non-volatile memory 434.

The program 440 may be stored in the memory 430 as software, and may include, for example, an operating system (OS) 442, a middleware 1044 or an application 1046.

The above-mentioned method for searching the deep neural network architecture may be implemented in the form of such a program 440 which may be stored in the memory 430 and which may be executed by the main processor 421 and/or the auxiliary processor 423.

The input device 450 may receive command or data to be used for other components of the electronic device 401 from outside the electronic device 401. The input device 450 may include, for example, a microphone, a mouse or a keyboard.

The sound output device 455 may output a sound signal to the outside of the electronic device 401. The sound output device 455 may include, for example, a speaker or a receiver. The speaker may be used for general purposes to play or record multimedia, and the receiver may be used to receive incoming calls.

The image display device 460 may visually provide information to the outside of the electronic device 401. The image display device may include, for example, a display, a holographic device, or a projector, and a control circuit that controls the display, the holographic device or the projector.

In some embodiments, the image display device 460 may include a touch circuit configured to detect a touch, or a sensor circuit, such as a pressure sensor, configured to measure the intensity of a force caused by the touch.

The audio module 470 may convert sound into an electrical signal and vice versa. In some embodiments, the audio module 470 may obtain sound through the input device 450, or may output sound through the sound output device 405 or through a headphone of an external electronic device 402 directly or wirelessly connected to the electronic device.

The sensor module 476 may detect, for example, the operating state of the electronic device 401 such as an output or a temperature, or an environmental state outside the electronic device 401 such as a user's state, and generate an electric signal or a data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor or an illuminance sensor.

The interface 477 may support one or more defined protocols to be used by the electronic device 401 directly or wirelessly connected to the external electronic device 402. In some embodiments, the interface 477 may include, for example, a high definition multimedia interface (HDMI), a universal serial bus (USB) interface, a secure digital (SEC) card interface, or an audio interface.

A connection terminal 478 may include a connector through which the electronic device 401 may be physically connected to the external electronic device 402. In some embodiments, the connection terminal 478 may include, for example, an HDMI connector, a USB connector, an SD card connector or an audio connector (such as a headphone connector).

The haptic module 479 may convert an electrical signal into, for example, a mechanical stimulus such as vibration or motion that may be perceived by the user through a tactile sensation or a kinesthetic sensation. In some embodiments, the haptic module 479 may include, for example, a motor, a piezoelectric element or an electrical stimulator.

The camera module 480 may capture still or motion images. In some embodiments, the camera module 480 may include one or more lenses, an image sensor, an image signal processor, a flash, and the like.

The power management module 488 may manage the power supplied to the electronic device 401. The power management module may be implemented, for example, as at least part of a power management integrated circuit (PMIC).

The battery 489 may provide power to at least one component of the electronic device 401. According to an embodiment, the battery 489 may include, for example, a non-rechargeable primary battery, a rechargeable secondary battery or a fuel cell.

The communication module 490 may support setting of a direct communication channel or a wireless communication channel between the electronic device 401 and an external electronic device such as, for example, the external electronic device 402, the external electronic device 404 or the server 408, and perform the communication through the set communication channels.

The communication module 490 may operate independently of the processor 420, and may include one or more communication processors that support direct communication or wireless communication.

In some embodiments, the communication module 490 may include a wireless communication module 492, such as, for example, a cellular communication module, a short range radio communication module or a global navigation satellite device (GNSS) communication module, or a wired communication module 494 such as, for example, a local area network (LAN) communication module or a power line communication (PLC) module.

The corresponding communication module among these communication modules may communicate with an external electronic device through a first network 498 such as, for example, Bluetooth™, Wi-Fi (Wireless-fidelity) direct or standard of the Infrared Data Association (IrDA) or a second network 499 such as, for example, a mobile communication network, an Internet or a long-distance communication network.

These various types of communication modules may be implemented as, for example, a single component, or may be implemented as a plurality of components separated from each other. The wireless communication module 492 may identify and authenticate the electronic device 401 inside the communication network such as the first network 498 or the second network 499, using the subscriber information stored in the subscriber identification module 496. The subscriber information may be in the form of a standard, such as, for example, the international mobile subscriber identity (IMSI) standard.

The antenna module 497 may transmit or receive signals or power to or from the outside of the electronic device 401. In some embodiments, the antenna module 497 may include one or more antennas, and at least one antenna suitable for the communication scheme used inside the communication network, such as the first network 498 or the second network 499 may be selected from this by the communication module 490. This allows the signal or power to be transmitted or received between the communication module and the external electronic device through at least one antenna selected.

At least some of the above components are interconnected, and signals may communicate between such components through an inter-peripheral communication scheme such as, for example, a bus, a general purpose input and output (GPIO), a serial peripheral interface (SPI), a mobile industry processor interface (MIPI).

In some embodiments, the command or data may be transmitted or received between the electronic device 401 and the external electronic device 404 connected to the second network 499. Each of the external electronic device 402 and external electronic device 404 may be the device of the same type as or different type from the electronic device 401. All or part of the operations to be performed on the electronic device 401 may be performed on one or more of the external electronic device 402, external electronic device 404 or server 408. For example, all or part of the operations to be performed on the electronic device 401 may be performed on one or more of the external electronic device 402, external electronic device 404 or server 408.

For example, if an electronic device 401 needs to perform a function or service automatically or in response to a request from a user or other device, the electronic device 401 performing that function or service may alternately or additionally ask one or more external electronic devices to perform at least a part of the function or service. One or more external electronic devices that have received a request may perform at least a part of the requested function or service or additional functions or additional services related to the request, and transfer the result of the execution to the electronic device 401. The electronic device 401 provides the result as at least a part of the response to the request with or without further processing of the result. For this purpose, for example, cloud computing, distributed computing or client-server computing technologies may be used.

The methods described above referring to FIG. 1, FIG. 2, FIG. 3, FIG. 4, FIG. 5, FIG. 6 and FIG. 7 may be implemented by software such as, for example, program 440 that includes one or more commands stored on a machine-readable storage medium (e.g., the internal memory 436 or the external memory 438). The machine-readable storage medium may be a non-transitory computer-readable storage medium, and may store the program 440 including the one or more commands.

For example, the processor 420 of the electronic device 401 may invoke at least a part of one or more commands stored in the storage medium, and may execute the part of one or more commands with or without use of one or more other components, under the control of the processor 420.

Accordingly, the device (e.g., electronic device 401) may operate to perform at least one function according to at least one invoked command. One or more commands may include code generated by a compiler or code that may be executed by an interpreter.

The machine-readable storage medium may be provided in the form of a non-volatile storage medium. The term “non-transitory” means that the storage medium is a tangible device and does not include only signals such as, for example, electromagnetic waves. However, the term does not distinguish a case where data is stored in the storage medium semi-permanently and a case where data is temporarily stored in the storage medium.

In some embodiments, the methods described above referring to FIG. 1, FIG. 2, FIG. 3, FIG. 4, FIG. 5, FIG. 6 and FIG. 7 may be provided in the form of computer program products. The computer program products may be traded as products between sellers and buyers. The computer program products are distributed, for example, in the form of a machine-readable storage medium such as a compact disc read-only memory (CD-ROM), or may be distributed online through, for example, an application store such as a play store, or directly between two user devices such as smartphones.

When distributed online, at least some of the computer program products may be temporarily generated on the machine-readable storage media such as a manufacturer's server, a server of the application store, or a memory of the relay server, or may be at least temporarily stored.

In some embodiments, each component of the above components such as, for example, a module or program, may include a single entity or multiple entities. One or more of the aforementioned components may be omitted, or one or more other components may be added. Alternatively or additionally, multiple components such as, for example, multiple modules or programs may be integrated into a single component. In this case, the integrated component may still perform one or more functions of each of the plurality of components in the same or similar manner to the corresponding one among the plurality of components prior to the integration. Operations performed by the module, the program, or other component may be executed sequentially, in parallel, repeatedly or heuristically, or one or more operations may be executed or omitted in a different order, or one or more other operations may be added.

In concluding the detailed description, those skilled in the art will appreciate that many variations and modifications may be made to the preferred embodiments without substantially departing from the principles of the present disclosure. Therefore, the disclosed embodiments are used in a generic and descriptive sense only and not for purposes of limitation.

What is claimed is:

1. A method for searching deep neural network architecture for computation offloading in a computing environment in which a computation is performed using a first device and a second device, the method comprising:
configuring a target deep network including a plurality of computation cells, each computation cell including a plurality of nodes, a weight between each node of the plurality of nodes, and an operation selector that selects a candidate operation between each node of the plurality of nodes,
partitioning the plurality of computation cells into a first portion in which the computation is performed on the first device and a second portion in which the computation is performed on the second device, the first portion including a transmission cell, and the transmission cell including a resource selector that determines whether each computation inside the transmission cell is processed by the first device or the second device, and a channel selector which determines a channel through which a computation result processed by the first device is transmitted to the second device; and
updating the weight, the operation selector, the resource selector, and the channel selector.

2. The method for searching deep neural network architecture of claim 1, wherein updating of the weight, the operation selector, the resource selector, and the channel selector includes
initializing the weight, the operation selector, the resource selector, and the channel selector,
inputting a finite length input arrangement to the target deep network to perform a feedforward propagation,
performing the computation on the first portion and the computation on the second portion to calculate a loss based on the computation on the first portion and the computation on the second portion; and
updating the weight, the operation selector, the resource selector, and the channel selector through a backward propagation based on the calculated loss.

3. The method for searching deep neural network architecture of claim 2, wherein calculating of the loss includes
calculating an offloading loss,
calculating a prediction loss, and
calculating a final loss through a weighted sum of the offloading loss and the prediction loss.

4. The method for searching deep neural network architecture of claim 1, wherein the transmission cell is a computation cell included in the first portion adjacent to a partitioning point between the first portion and the second portion.

5. The method for searching deep neural network architecture of claim 4, wherein the second portion includes a receiving cell, and the receiving cell has one input node.

6. The method for searching deep neural network architecture of claim 1, wherein the first device and the second device are connected by wired communication or wireless communication.

7. The method for searching deep neural network architecture of claim 6, wherein the first device includes a mobile device, and the second device includes an edge server.

8. The method for searching deep neural network architecture of claim 1, wherein the plurality of computation cells include
a normal cell, and
a reduced cell which reduces a spatial resolution of a feature map of the normal cell in half.

9. A system for searching deep neural network architecture for computation offloading in a computing environment in which a computation is performed using a first device and a second device, the system comprising:
a processor; and
a memory configured to store a command,
when the command in the memory is executed by the processor,
the processor is configured to:
configure a target deep network including a plurality of computation cells, each computation cell including a plurality of nodes, a weight between each node of the plurality of nodes, and an operation selector that selects a candidate operation between each node of the plurality of nodes,
partition the plurality of computation cells into a first portion in which the computation is performed on the first device and a second portion in which the computation is performed on the second device, the first portion including a transmission cell, and the transmission cell including a resource selector that determines whether each computation inside the transmission cell is processed by the first device or the second device, and a channel selector which determines a channel through which a computation result processed by the first device is transmitted to the second device, and
update the weight, the operation selector, the resource selector, and the channel selector.

10. The system for searching deep neural network architecture of claim 9, wherein updating of the weight, the operation selector, the resource selector, and the channel selector includes
initializing the weight, the operation selector, the resource selector, and the channel selector,
inputting a finite length input arrangement to the target deep network to perform a feedforward propagation,
performing the computation on the first portion and the computation on the second portion to calculate a loss based on the computation of the first portion and the computation on the second portion; and
updating the weight, the operation selector, the resource selector, and the channel selector through a backward propagation based on the calculated loss.

11. The system for searching deep neural network architecture of claim 10, wherein calculating of the loss includes
calculating an offloading loss,
calculating a prediction loss, and
calculating a final loss through a weighted sum of the offloading loss and the prediction loss.

12. The system for searching deep neural network architecture of claim 9, wherein the transmission cell is a computation cell included in the first portion adjacent to a partitioning point between the first portion and the second portion.

13. The system for searching deep neural network architecture of claim 12, wherein the second portion includes a receiving cell, and the receiving cell has one input node.

14. The system for searching deep neural network architecture of claim 9, wherein the first device and the second device are connected by wired communication or wireless communication.

15. The system for searching deep neural network architecture of claim 14, wherein the first device includes a mobile device, and the second device includes an edge server.

16. The system for searching deep neural network architecture of claim 9, wherein the plurality of computation cells include
a normal cell, and
a reduced cell which reduces a spatial resolution of a feature map of the normal cell in half.

17. A non-transitory computer-readable recording medium which stores a program that, when executed by a processor, performs a method for searching deep neural network architecture for computation offloading in a computing environment in which a computation is performed using a first device and a second device, the method for searching deep neural network architecture comprising:
configuring a target deep network including a plurality of computation cells, each computation cell including a plurality of nodes, a weight between each node of the plurality of nodes, and an operation selector that selects a candidate operation between each node of the plurality of nodes,
partitioning the plurality of computation cells into a first portion in which the computation is performed on the first device and a second portion in which the computation is performed on the second device, the first portion including a transmission cell, and the transmission cell including a resource selector that determines whether each computation inside the transmission cell is processed by the first device or the second device, and a channel selector which determines a channel through which a computation result processed by the first device is transmitted to the second device; and
updating the weight, the operation selector, the resource selector, and the channel selector.

18. The non-transitory computer-readable recording medium of claim 17, wherein updating of the weight, the operation selector, the resource selector, and the channel selector includes
initializing the weight, the operation selector, the resource selector, and the channel selector,
inputting a finite length input arrangement to the target deep network to perform a feedforward propagation,
performing the computation on the first portion and the computation on the second portion to calculate a loss based on the computation on the first portion and the computation on the second portion; and
updating the weight, the operation selector, the resource selector, and the channel selector through a backward propagation based on the calculated loss.

19. The non-transitory computer-readable recording medium of claim 18, wherein calculating of the loss includes
calculating an offloading loss,
calculating a prediction loss, and
calculating a final loss through a weighted sum of the offloading loss and the prediction loss.

20. The non-transitory computer-readable recording medium of claim 17, wherein the first device includes a mobile device, and the second device includes an edge server connected to the mobile device by a wired communication or a wireless communication.
